(19) United States
(12) Patent Application Publication
(10) Pub. No.: US 2017/0192330 A1
(43) Pub. Date: Jul. 6, 2017

(54) LIQUID CRYSTAL DEVICE (LCD) AND THE MANUFACTURING METHOD THEREOF

(71) Applicant: Shenzhen China Star Optoelectronics Technology Co. Ltd., Shenzhen, Guangdong (CN)

(72) Inventors: Cheng-hung CHEN, Shenzhen, Guangdong (CN); Jiali JIANG, Shenzhen, Guangdong (CN)

(73) Assignee: Shenzhen China Star Optoelectronics Technology Co. Ltd., Shenzhen, Guangdong (CN)

(21) Appl. No.: 14/892,686

(22) PCT Filed: Oct. 21, 2015
(86) PCT No.: PCT/CN2015/092359

§ 371 Date: Nov. 20, 2015

(30) Foreign Application Priority Data
Oct. 12, 2015 (CN) 201510659148.8

(51) Int. Cl. G02F 1/153; G02F 1/1368

(52) U.S. Cl. CPC G02F 1/153; G02F 1/1368; G02F 2001/133354

(57) ABSTRACT

A display panel, a LCD, and a manufacturing method of display panels are disclosed. The display panel includes at least one semiconductor transistor having a control end, an input end, and an output end. One of the input end and the output end receives the common voltage of the array substrate, and the other one connects with the common voltage of the color film substrate. Signals applying to the control end are controlled to connect or disconnect the common voltage of the array substrate and the common voltage of the color film substrate. When the common voltage of the array substrate and the common voltage of the color film substrate are disconnected, the voltage difference for aligning the liquid crystal layer be generated. When they are connected, the common voltage of the array substrate may be transmitted to the color film substrate.

### BACKGROUND OF THE INVENTION

1. Field of the Invention

The present disclosure relates to liquid crystal display technology, and more particularly to a LCD and the manufacturing method thereof.

2. Discussion of the Related Art

There are two main display technologies including In-Plane Switching (IPS) and Vertical Alignment (VA). VA alignment LCDs are characterized by attributes such as quick response time and high contrastness, and thus have been widely adopted.

Conventionally, a transfer pad is configured in a rim of the display panel of the LCD for connecting the Array-Vcom on the array substrate and the CF-Vcom on the color film substrate. After the alignment of the liquid crystal molecules are cured, usually, the scanning lines connected with the sub-pixels are charged or turn on, and the data lines connected with the sub-pixels are grounded. At the same time, the Array-Vcom of the array substrate receives alternating signals or other signals suitable for conducting the curing. As such, the level of the pixel electrode of the sub-pixels and the data line are maintained to be the ground level. The CF-Vcom of the color film substrate and the Array-Vcom of the array substrate are maintained to be the alternating signals, such that an appropriate voltage difference is generated at two ends of the liquid crystal layer, which is arranged between the pixel electrode of the sub-pixels and the common electrode of the color film substrate. The liquid crystal molecules may be aligned in accordance with the pretile angel, and thus the alignment of the liquid crystal layer may be cured under appropriate radiation.

Recently, self-adjust Vcom LCDs have been developed. The common voltage of the array substrate is performed by a functional circuit module, which respectively connects, directly or indirectly, to the pixel electrodes, data lines, and common voltage corresponding to the sub-pixels of the array substrate. At this moment, the change of the common voltage of the array substrate may directly affect the voltage change of the pixel electrode. The voltage difference between the pixel electrode and the color film substrate may not be appropriate for the alignment of the liquid crystal layer, which results in undesirable alignment or the alignment cannot be conducted.

In view of the above, after the liquid crystal panel is assembled, the solution of adopting the transfer pad to connect the common voltage on the array substrate and the common voltage on the color film substrate cannot satisfy the alignment requirement of the self-adjust Vcom LCDs.

### SUMMARY

The object of the invention is to provide a LCD and the manufacturing method thereof. With such configuration, stable voltage difference for liquid crystal alignment may be formed between the color film substrate and the array substrate

In one aspect, a display panel includes:

an array substrate and a color film substrate opposite to each other, and the array substrate and the color film substrate are spaced apart from each other, wherein the display panel includes at least one semiconductor transistor having a control end, an input end, and an output end, one of the input end and the output end receives the common voltage of the array substrate, and the other one connects with the common voltage of the color film substrate, signals applying to the control end are controlled to connect or disconnect the common voltage of the array substrate and the common voltage of the color film substrate.

Wherein during an alignment process of the display panel, a first control voltage is applied to the control end such that the input end and the output end are disconnected, and the common voltage of the array substrate and the common voltage of the color film substrate are disconnect; and after the alignment process and in a normal operation period of the display panel, a second control voltage is applied to the control end such that the input end and the output end are connected, and the common voltage of the array substrate and the common voltage of the color film substrate are connected.

Wherein the semiconductor transistor is a thin film transistor (TFT), wherein the control end is a gate of the TFT, the input end is a source of the TFT, and the output end is a drain of the TFT.

Wherein the first control voltage is a low voltage, and the second control voltage is a high voltage.

Wherein the first control voltage are the signals in a range of −8 v and 0, and the second control voltage are the signals in a range of 25 v and 35 v.

Wherein the semiconductor transistor is arranged within a non-display area of the display panel.

Wherein the semiconductor transistors are arranged on the array substrate, the semiconductor transistors are spaced apart from each other, and the semiconductor transistors are in a rim of the non-display area.

Wherein the semiconductor transistors are arranged on the color film substrate, the semiconductor transistors are spaced apart from each other, and the semiconductor transistors are in a rim of the non-display area.

In another aspect, a liquid crystal device (LCD) includes: a display panel comprising an array substrate and a color film substrate opposite to each other, and the array substrate and the color film substrate are spaced apart from each other, wherein the display panel includes at least one semiconductor transistor having a control end, an input end, and an output end, one of the input end and the output end receives the common voltage of the array substrate, and the other one connects with the common voltage of the color film substrate, signals applying to the control end are controlled to connect or disconnect the common voltage of the array substrate and the common voltage of the color film substrate.

Wherein during an alignment process of the display panel, a first control voltage is applied to the control end such that the input end and the output end are disconnected, and the common voltage of the array substrate and the common voltage of the color film substrate are disconnect; and after the alignment process and in a normal operation period of the display panel, a second control voltage is applied to the control end such that the input end and the output end are connected, and the common voltage of the array substrate and the common voltage of the color film substrate are connected.

Wherein the semiconductor transistor is a TFT, wherein the control end is a gate of the TFT, the input end is a source of the TFT, and the output end is a drain of the TFT.

Wherein the first control voltage is a low voltage, and the second control voltage is a high voltage.

Wherein the first control voltage are the signals in a range of −8 v and 0, and the second control voltage are the signals in a range of 25 v and 35 v.

Wherein the semiconductor transistor is arranged within a non-display area of the display panel.

Wherein the semiconductor transistors are arranged on the array substrate, the semiconductor transistors are spaced apart from each other, and the semiconductor transistors are in a rim of the non-display area.

Wherein the semiconductor transistors are arranged on the color film substrate, the semiconductor transistors are spaced apart from each other, and the semiconductor transistors are in a rim of the non-display area.

In another aspect, a manufacturing method of display panels, the display panel includes an array substrate and the color film substrate opposite to the array substrate, and the array substrate is spaced apart from the color film substrate, the method including: arranging at least one semiconductor transistor on the display panel, and the semiconductor transistor includes a control end, an input end, and an output end; connecting one of the input end and the output end to the common voltage of the array substrate, and connecting the other one to the common voltage of the color film substrate; applying a first control voltage to the control end during the alignment process such that the input end and the output end are turned off, and the common voltage of the array substrate and the common voltage of the color film substrate are disconnected; and applying a second control voltage to the control end after the alignment process and in the normal operation period such that the input end and the output end are connected, and the common voltage of the array substrate and the common voltage of the color film substrate are connected.

In view of the above, at least one semiconductor transistor having a control end, an input end, and an output end on the display panel. One of the input end and the output end connects with the common voltage of the array substrate, and the other one connects with the common voltage of the color film substrate. By controlling the signals applied to the control end, the common voltage of the array substrate and the common voltage of the color film substrate are turned on or off. After the display panel is assembled, there is no need to configure the transfer pad in a rim of the display panel. Compared to the conventional technology, the signals of the control end of the semiconductor transistor is controlled such that the common voltage of the array substrate and the common voltage of the color film substrate are turned on and off. When the common voltage of the array substrate and the common voltage of the color film substrate are disconnected, the voltage of the pixel electrode of the array substrate and the common voltage of the color film substrate are independent signals and can be independently controllable, and thus may be adopted to realize a predetermined voltage difference for aligning the liquid crystal layer between the array substrate and the color film substrate. In this way, the self-adjust Vcom display or LCD may be normally aligned so as to enhance the display performance. When the common voltage of the array substrate and the common voltage of the color film substrate are connected, the common voltage on the array substrate may be transmitted to the color film substrate.

### BRIEF DESCRIPTION OF THE DRAWINGS

FIG. 1 is a schematic view of the LCD in accordance with one embodiment.

FIG. 2 is a cross-sectional view of the display panel of FIG. 1 along the “C-C” line.

FIG. 3 is a schematic view of the semiconductor transistor, which is a thin film transistor (TFT), of FIG. 1.

FIG. 4 is an equivalent circuit view of the display panel having a plurality of sub-pixel cells of FIG. 1.

FIG. 5 is a timing diagram of the predetermined AC voltage difference formed in the liquid crystal layer of FIG. 4.

FIG. 6 is a schematic view of the display panel in accordance with another embodiment.

FIG. 7 is a schematic view of the LCD in accordance with one embodiment.

FIG. 8 is flowchart of a manufacturing method of display panels in accordance with one embodiment.

### DETAILED DESCRIPTION OF THE EMBODIMENTS

Embodiments of the invention will now be described more fully hereinafter with reference to the accompanying drawings, in which embodiments of the invention are shown.

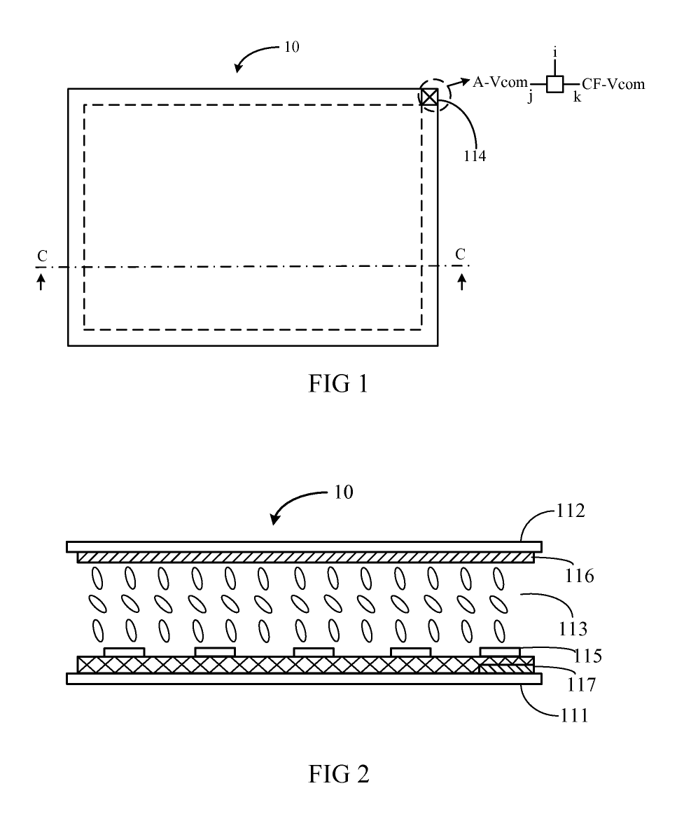

FIG. 1 is a schematic view of the LCD in accordance with one embodiment. FIG. 2 is a cross-sectional view of the display panel of FIG. 1 along the “C-C” line. As shown in FIG. 2, the display panel 10 includes an array substrate 111, a color film substrate 112 spaced apart from each other, and a liquid crystal layer 113 between the color film substrate 112 and the array substrate 111. Referring to FIG. 1, the display panel 10 includes at least one semiconductor transistor 114, which includes a control end (i), an input end (j), and an output end (k). One of the input end (j) and output end (k) connects with the common voltage (Array-Vcom) of the array substrate 111, and the other end connects with the common voltage (CF-Vcom) of the color film substrate 112. As shown in FIG. 1, the input end (j) connects with the common voltage (Array-Vcom) of the array substrate 111, which is shown as A-Vcom. The output end (k) connects with the common voltage (CF-Vcom) of the color film substrate 112. The signals applied to the control end (i) are controlled such that the common voltage (Array-Vcom) of the array substrate 111 and the common voltage (CF-Vcom) of the color film substrate 112 are turned on or turned off.

The common voltage (Array-Vcom) of the array substrate 111 and the common voltage (CF-Vcom) of the color film substrate 112 are controlled to be turned on or off by configuring the semiconductor transistor 114 without the transfer pad.

Referring to FIG. 2, the pixel electrode 115 and the common electrode 117 are arranged on an up surface of the array substrate 111, and the pixel electrode 115 and the common electrode 117 are insulated from each other. The common electrode 116 is arranged on a surface of the color film substrate 112. The signals applied on the common electrode 117 of the array substrate 111 are the common voltage (Array-Vcom) of the array substrate 111. The signals applied on the common electrode 116 of the color film substrate 112 are the common voltage (CF-Vcom) of the color film substrate 112.

When the display panel 10 conducts the alignment process, a first control voltage is applied to the control end (i) such that the input end (j) and the output end (k) are turned off. Further, the common voltage (Array-Vcom) of the array substrate 111 and the common voltage (CF-Vcom) of the color film substrate 112 are disconnected. At this moment, the input end (j) and the output end (k) of the semiconductor transistor 114 are turned off, and the leaked current is smaller. When the common voltage (CF-Vcom) for the alignment process is applied to the common electrode 116 of the color film substrate 112, the common voltage (CF-Vcom) may not transmitted to the common electrode 117 of the array substrate 111 via the semiconductor transistor 114 to form the common voltage (Array-Vcom). As such, the voltage of the pixel electrode 115 may not be affected. That is, the voltage difference exists between the voltage of the pixel electrode 115 and the common voltage (CF-Vcom) of the color film substrate 112, which contributes to the generation of the predetermined voltage difference between the array substrate 111 and the color film substrate 112. After the alignment process, the display panel 10 may operate normally. A second control voltage is applied to the control end (i) such that the input end (j) and the output end (k) are connected. As such, the common voltage (Array-Vcom) of the array substrate 111 and the common voltage (CF-Vcom) of the color film substrate 112 are connected such that the display panel 10 may display normally.

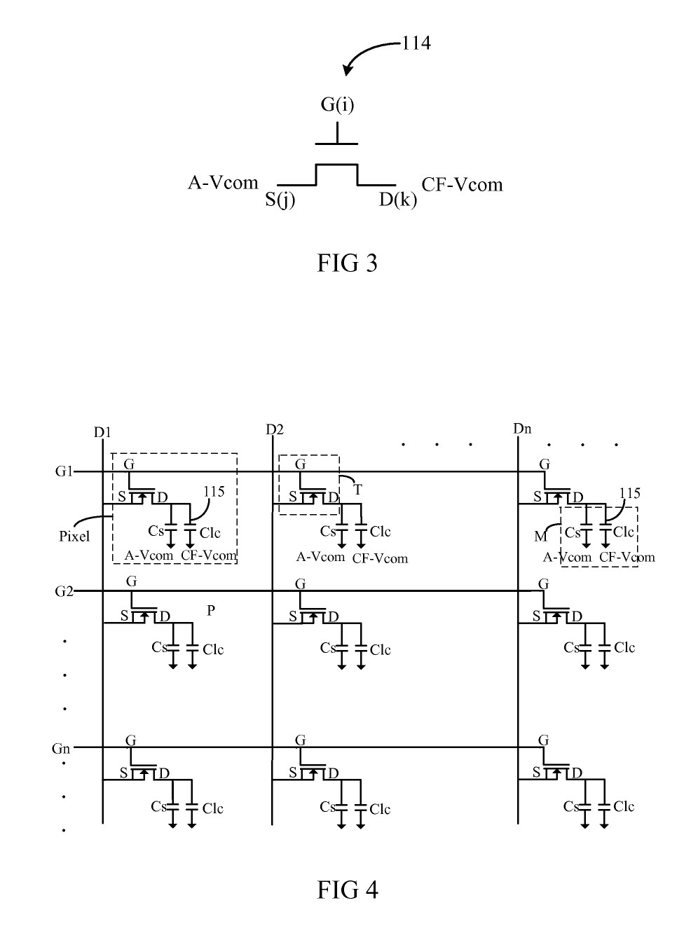

FIG. 3 is a schematic view of the semiconductor transistor, which is a thin film transistor (TFT), of FIG. 1. Referring to FIGS. 1 and 3, in one embodiment, the semiconductor transistor 114 is the TFT. As shown in FIG. 3, the semiconductor transistor 114 is the N-type TFT. At this moment, the control end (i) corresponds to the gate (G) of the TFT, the input end (j) corresponds to the source (S) of the TFT, and the output end (k) relates to the drain (D) of the TFT. In other embodiments, the input end (j) may be the drain (D) of the TFT, the output end (k) may be the source (S) of the TFT.

When the TFT is of the N-type and the voltage applied to the gate (G) is low, the source (S) and the drain (D) of the TFT are turned off. When the voltage applied to the gate (G) is high, the source (S) and the drain (D) are turned on.

It can be understood that the first control voltage applied to the control end (i) is the low voltage such that the input end (j) and the output end (k) are turned off. The second control voltage applied to the control end (i) is the high voltage such that the input end (j) and the output end (k) are turned on. In one embodiment, the first control voltage is the signals in a range of −8 v and 0, and the second control voltage is the signals in a range of 25 v and 35 v.

When the TFT is of the P-type and the voltage applied to the gate (G) is high, the source (S) and the drain (D) of the TFT are turned off. When the voltage applied to the gate (G) is low, the source (S) and the drain (D) are turned on.

In other embodiments, the semiconductor transistor 114 may be FET, such as JEFT or MOSFET. At this moment, the control end (i) corresponds to the gate (G) of the FET, the input end (j) corresponds to the source (S) of the FET, and the output end (k) corresponds to the drain (D) of the FET. The operations of the semiconductor transistor 114 are the same with that of the TFT, and thus are omitted hereinafter.

FIG. 4 is an equivalent circuit view of the display panel having a plurality of sub-pixel cells of FIG. 1. As shown in FIG. 4, the display panel 10 includes a plurality of sub-pixel cells (Pixel) arranged in a matrix along a row direction and a column direction, a plurality of data lines along the column direction, and a plurality of scanning lines along the row direction. In FIG. 4, Dn relates to the n-th data line, Gn relates to the n-th scanning line, n is an integer, and wherein each of the sub-pixel units (Pixels) 114 includes a pixel field effect transistor (T) and a capacitance sub-unit (M). The pixel field effect transistor (T) includes a gate (G), a source (S) and a drain (D). The gate (G) connects the corresponding scanning line to receive the driving signals on the driving signals of corresponding row, and the source (S) connects to the corresponding data line to receive the driving signals of corresponding column. The capacitance sub-unit M includes a liquid crystal capacitor (Clc) and a storage capacitor (Cs) formed by the liquid crystal molecules within the liquid crystal layer 113, and the liquid crystal capacitor (Clc) and the controllable switch stands side by side.

The same ends of the liquid crystal capacitor (Clc) and the storage capacitor (Cs) within each of the pixel field effect transistors (T) connect to the drain (D) of the corresponding field effect transistor (T). Specifically, the drain (D) of the field effect transistor (T) connects to the pixel electrode 115, as shown in FIG. 2, such that one end of the liquid crystal capacitor (Clc) connects to the pixel electrode 115, and the other end of the liquid crystal capacitor (Clc) connects to the common electrode 116 of the color film substrate 112 so as to receive the CF-Vcom of the color film substrate 112. The other end of the controllable switch connects to the common electrode 117 of the array substrate 111 to receive the Array-Vcom of the array substrate 111, i.e., A-Vcom in FIG. 4. Before the assembled display panel 110 is bonded with the flexible circuit board 120 and before the alignment process, the common voltage (Array-Vcom) of the array substrate 111 and the common voltage (CF-Vcom) of the color film substrate 112 are disconnected. By turning on the gate (G) of each of the field effect transistors (T) and inputting the third control voltage via the data line connected with the pixel field effect transistor (T), the voltage of the pixel electrode 115 is the third control voltage. At the same time, the common voltage (CF-Vcom) of the color film substrate 112 receives the fourth control voltage to form the predetermined AC voltage difference between two ends of the liquid crystal layer 113.

The array substrate 111 on the display panel 110 includes the plurality of data lines arranged along the column direction, the plurality of scanning lines arranged along the row direction, and the field effect transistor (T) and the pixel electrode 115 arranged within the area defined by adjacent data line and the scanning line. Each of the field effect transistor (T) includes a gate (G), a source (S) and a drain (D).

The source (S) of the pixel field effect transistor (T) connects to the corresponding scanning line to receive the driving signals of corresponding row, the source (S) of the pixel field effect transistor (T) connects to the corresponding data line to receive the driving signals to receive the driving signals of corresponding column, and the drain (D) connects to the corresponding pixel electrode 115.

The liquid crystal molecules within the liquid crystal layer 113 form the liquid crystal capacitor (Clc). One end of the liquid crystal capacitor (Clc) connects to the pixel electrode 115, and the other end of the liquid crystal capacitor (Clc) connects to the common voltage (CF-Vcom) on the color film substrate 112. After the color film substrate 112, the array substrate 111, and the liquid crystal layer 113 are assembled and before bonding with the flexible circuit board 120, before the alignment process, the common voltage (Array-Vcom) of the array substrate 111 and the common voltage (CF-Vcom) of the color film substrate 112 are disconnected. By turning on the gate (G) of each of the pixel field effect transistors (T), the voltage of the pixel electrode 115 is the third control voltage. Thus, the source (S) of the pixel field effect transistor (T) connected with the data line is the third control voltage, and the drain (D) of the corresponding pixel field effect transistor (T) is also the third control voltage. Further, the voltage of the corresponding pixel electrode 115 is also the third control voltage. At the same time, the common voltage (CF-Vcom) of the color film substrate 112 receives the fourth control voltage to form the predetermined AC voltage difference between two ends of the liquid crystal layer 113.

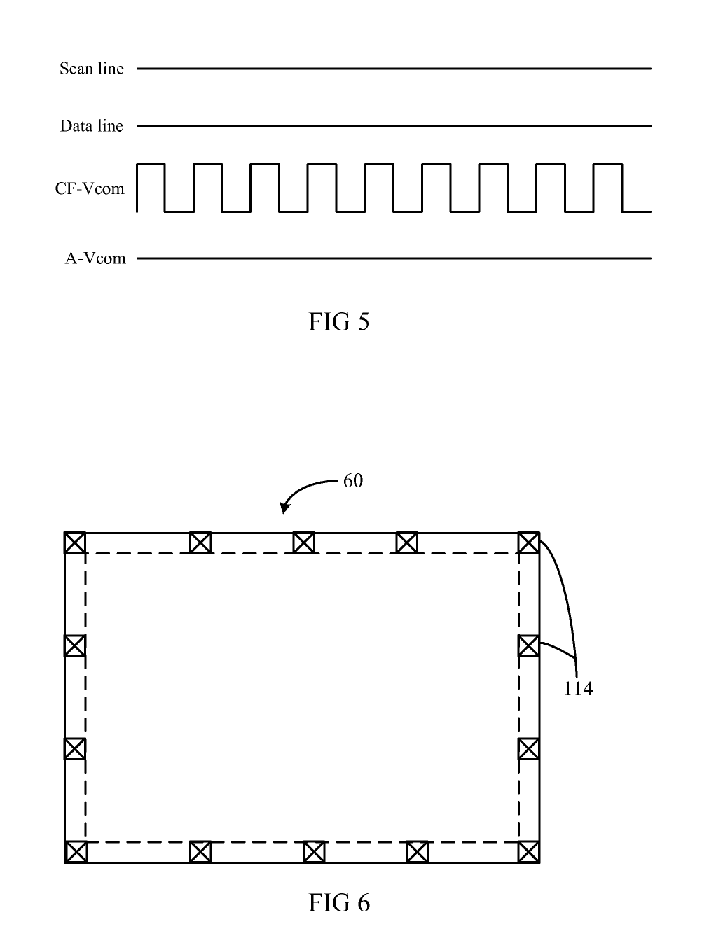

FIG. 5 is a timing diagram of the predetermined AC voltage difference formed in the liquid crystal layer of FIG. 4. As shown in FIG. 5, the third control voltage is the grounded zero voltage, and the fourth control voltage is the AC voltage. The AC voltage is applied to the scanning lines along the row direction, which is referred to as Scan line in FIG. 5, the gate (G) of the field effect transistor (T) within of each of the sub-pixel cells (Pixels) is turned on so as to apply the grounded zero voltage to the corresponding data line, which is referred to as Data line in FIG. 5. At this moment, the pixel electrode 115 also includes the grounded zero voltage. The self-adjust Vcom LCD transmits the signals on the data line to the common electrode 117 of the array substrate 111. At this moment, the Array-Vcom is also the grounded zero voltage. When the common electrode 116 of the color film substrate 112 applies the AC voltage as the common voltage (CF-Vcom), the AC voltage difference exists between the two ends of the liquid crystal layer 113, i.e., between the pixel electrode 115 and the common electrode 116 of the color film substrate 112. In this way, the liquid crystal molecules within the liquid crystal layer 113 may be aligned in accordance with the pretile angel, and thus the alignment of the liquid crystal layer may be cured under appropriate radiation.

In other embodiments, the third control voltage may be AC voltage, and the fourth control voltage may be the grounded zero voltage. However, the third control voltage and the fourth control voltage may be of other voltage signals capable of forming the predetermined AC voltage difference suitable for the alignment of liquid crystal layer.

Referring to FIG. 1, the semiconductor transistor 114 is arranged within the non-display area of the display panel 10. As shown in FIG. 1, the area defined by the dashed line relates to the display area of the display panel 110, and within the area, the liquid crystal layer 113 is arranged between the array substrate 111 and the color film substrate 112. The remaining area are non-display area, and there is no liquid crystal layer 113 between the array substrate 111 and the color film substrate 112 within the area. The non-display area is configured for connecting with the external circuit.

It can be understood that the array substrate 111 and the color film substrate 112 may be divided into a display area and a non-display area respectively corresponding to the color film substrate 112 or the array substrate 111, and the liquid crystal layer 113 may be clasped between the color film substrate 112 and the array substrate 111 or not.

FIG. 6 is a schematic view of the display panel in accordance with another embodiment. As shown in FIG. 6, the components of the display panel 60 that are similar to those in the display panel 10 have the same reference numerals. The difference between the display panel 60 and the display panel in FIG. 1 resides in that the display panel 60 includes a plurality of semiconductor transistors 114, which are arranged within the non-display area of the display panel 60 and are spaced apart from each other. Specifically, the semiconductor transistors 114 may be arranged in a rim of the non-display area.

Further, the semiconductor transistors 114 are arranged on the array substrate 111 and are spaced apart from each other. In addition, the semiconductor transistors 114 are arranged in a rim of the non-display area of the array substrate 111. Alternatively, the semiconductor transistors 114 may be arranged on the color film substrate 112, and the semiconductor transistors 114 are spaced apart from each other, and the semiconductor transistors 114 are arranged in the rim of the non-display area.

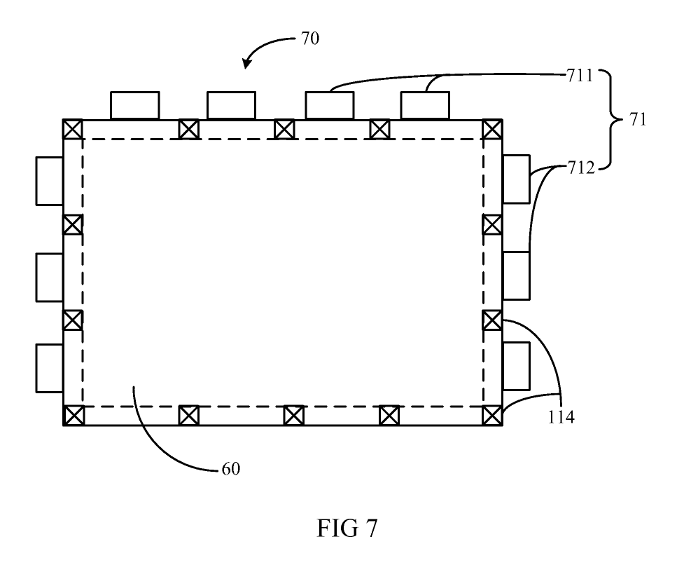

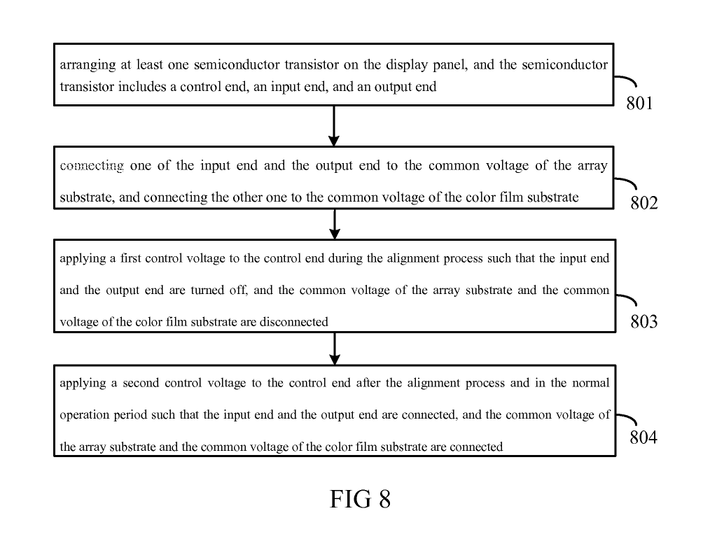

FIG. 7 is a schematic view of the LCD in accordance with one embodiment. As shown in FIG. 7, the display device 70 includes the above display panel. That is, the display device 70 includes the display panel 10, 60 in FIG. 1 or 6. The same components are marked by the same reference numeral. As shown in FIG. 7, the display device 70 includes the display panel 60.

In addition, the display device 70 also includes a flexible circuit board 71 for driving the display panel 10. The flexible circuit board 71 may be chip on film (COF) flexible board and the driving chips on the flexible board.

Referring to FIG. 7, the flexible circuit board 71 includes a plurality of source sub-flexible circuit boards 711 in a top of the display panel 60 and a plurality of gate sub-flexible circuit boards 712 at two lateral sides of the display panel 60. In the example shown in FIG. 8, the flexible circuit board 71 includes four source sub-flexible circuit boards 711 and six gate sub-flexible circuit boards 712 respectively applying the column driving signals to the data line on the array substrate 111 and applying the row driving signals to the scanning line on the array substrate 111.

Usually, the LCD 70 includes at least two source sub-flexible circuit boards 711 and at least two gate sub-flexible circuit boards 712, but the present disclosure is not limited thereto. In other embodiments, the LCD 70 may include one source sub-flexible circuit boards 711 and one gate sub-flexible circuit boards 712 when the dimension of the display panel is small.

During the alignment process of the display panel 10, the flexible circuit board 71 is bonded with the display panel 60. After being bonding, the flexible circuit board 71 is arranged within the non-display area of the display panel 10. Further, as shown in FIG. 7, the source sub-flexible circuit boards 711 and the gate sub-flexible circuit boards 712 are spaced apart from the semiconductor transistor 114.

FIG. 8 is flowchart of a manufacturing method of display panels in accordance with one embodiment. The display panel includes the array substrate and the color film substrate opposite to each other. The manufacturing method includes the following steps.

In block 801, at least one semiconductor transistor is arranged on the display panel. The semiconductor transistor includes a control end, an input end, and an output end.

In block 802, one of the input end and the output end receives the common voltage of the array substrate, and the other one receives the common voltage of the color film substrate.

In block 803, during the alignment process, the first control voltage is applied to the control end such that the input end and the output end are turned off. As such, the common voltage of the array substrate and the common voltage of the color film substrate are disconnected.

In block 804, after the alignment process and in the normal operation period, the second control voltage is applied to the control end such that the input end and the output end are connected. As such, the common voltage of the array substrate and the common voltage of the color film substrate are connected.

The display panel is the same with the display panel 10 and the display panel 60 in FIGS. 1 and 6, and the steps 801 to 804 may be executed by the components of the above LCD.

In block 803, the common voltage on the array substrate and the common voltage on the color film substrate are configured to be disconnected, wherein the transfer pad is not provided on the display panel, and such configuration is accomplished by configuring the input end and the output end of the semiconductor transistor.

After the block 803 and before the block 804, the manufacturing method further includes the following step.

Turning on the gate of each of the FETs.

Inputting the third common voltage to the data line connected by each of the FETs such that the voltage of the pixel electrode connected by the FETs is the third control voltage. At the same time, the common voltage of the color film substrate receives the fourth control voltage so as to form the predetermined AC voltage difference on the liquid crystal layer.

The third control voltage is the grounded zero voltage, and the fourth control voltage is the AC voltage. In other embodiments, the third control voltage is the AC voltage, and the fourth control voltage is the grounded zero voltage. However, the third control voltage and the fourth control voltage may be of other voltage signals capable of forming the predetermined AC voltage difference suitable for the alignment of liquid crystal layer.

Further, after the step of forming the predetermined AC voltage difference on the liquid crystal layer and before the block 804, the manufacturing method further includes the following steps.

Radiating the liquid crystal layer with the predetermined voltage difference such that the liquid crystal molecules may be aligned and cured in accordance with the pretile angel. This step is for aligning and curing the liquid crystal layer.

In view of the above, at least one semiconductor transistor having a control end, an input end, and an output end on the display panel. One of the input end and the output end connects with the common voltage of the array substrate, and the other one connects with the common voltage of the color film substrate. By controlling the signals applied to the control end, the common voltage of the array substrate and the common voltage of the color film substrate are turned on or off. After the display panel is assembled, there is no need to configure the transfer pad in a rim of the display panel. Compared to the conventional technology, the signals of the control end of the semiconductor transistor is controlled such that the common voltage of the array substrate and the common voltage of the color film substrate are turned on and off.

When the common voltage of the array substrate and the common voltage of the color film substrate are disconnected, the voltage of the pixel electrode of the array substrate and the common voltage of the color film substrate are independent signals and can be independently controllable, and thus may be adopted to realize a predetermined voltage difference for aligning the liquid crystal layer between the array substrate and the color film substrate. In this way, the self-adjust Vcom display or LCD may be normally aligned so as to enhance the display performance. When the common voltage of the array substrate and the common voltage of the color film substrate are connected, the common voltage on the array substrate may be transmitted to the color film substrate.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A display panel, comprising:
an array substrate and a color film substrate opposite to each other, and the array substrate and the color film substrate are spaced apart from each other, wherein the display panel comprises at least one semiconductor transistor having a control end, an input end, and an output end, one of the input end and the output end receives the common voltage of the array substrate, and the other one connects with the common voltage of the color film substrate, signals applying to the control end are controlled to connect or disconnect the common voltage of the array substrate and the common voltage of the color film substrate.

2. The display panel as claimed in claim 1, wherein during an alignment process of the display panel, a first control voltage is applied to the control end such that the input end and the output end are disconnected, and the common voltage of the array substrate and the common voltage of the color film substrate are disconnect; and
after the alignment process and in a normal operation period of the display panel, a second control voltage is applied to the control end such that the input end and the output end are connected, and the common voltage of the array substrate and the common voltage of the color film substrate are connected.

3. The display panel as claimed in claim 1, wherein the semiconductor transistor is a thin film transistor (TFT), wherein the control end is a gate of the TFT, the input end is a source of the TFT, and the output end is a drain of the TFT.

4. The display panel as claimed in claim 2, wherein the first control voltage is a low voltage, and the second control voltage is a high voltage.

5. The display panel as claimed in claim 4, wherein the first control voltage are the signals in a range of −8 v and 0, and the second control voltage are the signals in a range of 25 v and 35 v.

6. The display panel as claimed in claim 1, wherein the semiconductor transistor is arranged within a non-display area of the display panel.

7. The display panel as claimed in claim 1, wherein the semiconductor transistors are arranged on the array substrate, the semiconductor transistors are spaced apart from each other, and the semiconductor transistors are in a rim of the non-display area.

8. The display panel as claimed in claim 6, wherein the semiconductor transistors are arranged on the color film substrate, the semiconductor transistors are spaced apart from each other, and the semiconductor transistors are in a rim of the non-display area.

9. A liquid crystal device (LCD), comprising:
a display panel comprising an array substrate and a color film substrate opposite to each other, and the array substrate and the color film substrate are spaced apart from each other, wherein the display panel comprises at least one semiconductor transistor having a control end, an input end, and an output end, one of the input end and the output end receives the common voltage of the array substrate, and the other one connects with the common voltage of the color film substrate, signals applying to the control end are controlled to connect or disconnect the common voltage of the array substrate and the common voltage of the color film substrate.

10. The LCD as claimed in claim 9, wherein during an alignment process of the display panel, a first control voltage is applied to the control end such that the input end and the output end are disconnected, and the common voltage of the array substrate and the common voltage of the color film substrate are disconnect; and
after the alignment process and in a normal operation period of the display panel, a second control voltage is applied to the control end such that the input end and the output end are connected, and the common voltage of the array substrate and the common voltage of the color film substrate are connected.

11. The LCD as claimed in claim 9, wherein the semiconductor transistor is a TFT, wherein the control end is a gate of the TFT, the input end is a source of the TFT, and the output end is a drain of the TFT.

12. The LCD as claimed in claim 10, wherein the first control voltage is a low voltage, and the second control voltage is a high voltage.

13. The LCD as claimed in claim 12, wherein the first control voltage are the signals in a range of −8 v and 0, and the second control voltage are the signals in a range of 25 v and 35 v.

14. The LCD as claimed in claim 9, wherein the semiconductor transistor is arranged within a non-display area of the display panel.

15. The LCD as claimed in claim 14, wherein the semiconductor transistors are arranged on the array substrate, the semiconductor transistors are spaced apart from each other, and the semiconductor transistors are in a rim of the non-display area.

16. The LCD as claimed in claim 14, wherein the semiconductor transistors are arranged on the color film substrate, the semiconductor transistors are spaced apart from each other, and the semiconductor transistors are in a rim of the non-display area.

17. A manufacturing method of display panels, the display panel comprises an array substrate and the color film substrate opposite to the array substrate, and the array substrate is spaced apart from the color film substrate, the method comprising:
arranging at least one semiconductor transistor on the display panel, and the semiconductor transistor includes a control end, an input end, and an output end;
connecting one of the input end and the output end to the common voltage of the array substrate, and connecting the other one to the common voltage of the color film substrate;
applying a first control voltage to the control end during the alignment process such that the input end and the output end are turned off, and the common voltage of the array substrate and the common voltage of the color film substrate are disconnected; and
applying a second control voltage to the control end after the alignment process and in the normal operation period such that the input end and the output end are connected, and the common voltage of the array substrate and the common voltage of the color film substrate are connected.
